(19) United States
(12) Patent Application Publication
(10) Pub. No.: US 2007/0085891 A1
(43) Pub. Date: Apr. 19, 2007

(54) Controlling print media advance in hardcopy process

(75) Inventors: Pasqual Batalla, Sant Cugat Valles (ES); Jordi Sender, Barcelona (ES); David Claramunt, Sant Esteve Sesrovires (ES); Juan Manuel Valero, Sant Cugat del Valles (ES); Oriol Borrell, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/248,157

(22) Filed: Oct. 13, 2005

(51) Int. Cl. B41J 2/01

(52) U.S. Cl. 347/104; 347/5

(57) ABSTRACT

In a hardcopy device, a print media advance mechanism for moving a print media past a printhead and including a device for adjusting the size of successive advance movements in dependence n printing parameters, the adjusting device is capable of adjusting said size to have an increased resolution, at least in a part of said range. In some embodiments the hardcopy device is set in dependence or one or more of: print mode being employed, ink density, print media width and whether a sheet or roll media is being employed. In some embodiments, a printing operation is preceded by calibrating operation in which a plurality of patterns are printed corresponding to different sizes of media advance and a user selects the optimal value based on visual inspection of the patterns; the different sizes are distributed within a range of values in a non-linear manner.

### BACKGROUND OF THE INVENTION

The present invention relates to hardcopy devices and to a method for controlling the advance of print media in hard copy devices such as inkjet printers.

In ink-jet printers, and especially in large format ink-jet printers or plotters, the printed matter undergoes dot placement errors caused by the expansion of the print media or substrate as it interacts with the ink and also due to the properties of the paper loaded (calliper, thickness, slippage). Each paper has slightly different properties and this may also affect the media advance. For example, print medias such as bond and coated papers, vellum, natural tracing and translucent medias expand to different degrees when brought into contact with the water of water-based inks. On the other hand, some print medias, such as polyester films or photographic papers, do not expand or expand only by a negligible amount. The variation of dot placement with different print medias causes a degradation in print quality.

The external conditions also affect the advance of the paper because they may affect properties such as slippage and thickness. Expansion is another big factor that affects the media advance (it highly depends on the ink density, type of paper and external conditions). The print mode also affects the expansion; although the expansion is worst for slow print modes, the fact of printing with a higher number of passes hides the effects of the expansion to a large extent. In particular, graininess and horizontal banding with white or dark bands can occur in images and area fills, which are regions of relatively high ink density. Furthermore, roughness and overlaps or white gaps can occur in lines and text, although the human eye is less sensitive to such defects.

The quality of a print media such as paper can also change with environmental conditions. In particular, the amount of water absorbed and the resulting paper expansion and dot placement error can depend upon the prevailing temperature and/or the relative humidity.

One method which has been used to reduce the above problems is to adjust the size of the print media advance “a” in dependence on one of the various factors. Thus for a paper which expands on contact with ink, the size of each print media advance is increased slightly. In one method, a user keys in data concerning a relevant factor, and a look-up table is used to determine the corresponding size of the print media advance to be used. In an alternative method, a number of equally-spaced fixed values for the print media advance are available; a test pattern is printed out for each available value of the print media advance and a visual inspection undertaken by the user to determine which advance size gives the best impression, e.g. with minimal bands or gaps.

### SUMMARY OF THE INVENTION

Aspects of the present invention seek to provide hardcopy devices and methods of operating hardcopy devices with improved print quality.

According to an aspect of the invention there is provided a hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, wherein said adjusting device is capable of adjusting said size to have an increased resolution, at least in a part of said range.

Preferably said printing parameters are selected from a first group of parameters comprising print media being employed and environmental conditions, and wherein said adjusting device adjusts said size to have said increased resolution in dependence upon or more of a second group of parameters comprising print mode being employed, ink density, print media width, and whether a sheet or roll media is being used.

The invention also provides a method of calibrating a hardcopy device in which a first adjustment of the size of successive print media advance movements is made in dependence on printing parameters and a second adjustment is made with increased accuracy in dependence on one or more further printing parameters.

The invention further provides a hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, wherein said printing parameters include at least one of print mode being employed and ink density.

The invention also provides a method of calibrating a hardcopy device in which an adjustment of the size of successive print media advance movements is made in dependence on the print mode being employed and/or ink density.

The invention further provides a hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, said size being capable of having one of a plurality of discrete values within a range of values, wherein the said values are distributed within said range in non-linear manner.

Preferably said values are closer together in the centre of said range than towards the ends of the range.

The hardcopy device may include a user input device for setting a central value of said range of values. If there is an odd number of values, the set value may be the centre value. The set value preferably depends on the type of print media being used.

A preferred hardcopy device includes a driver for causing said printhead to apply ink to a print media in a plurality of patterns, each pattern corresponding to a respective one of said discrete values of said size, and the device further includes a user input device for selecting a desired discrete value as a result of visual inspection of said patterns. The invention further provides a method of calibrating such a hardcopy device for a printing operation, wherein in a first printing step, said driver causes said printhead to apply ink to said print media in a first plurality of patterns corresponding to a first range of discrete values, and, in the event that visual inspection reveals that none of said patterns in said first plurality corresponds to a desired discrete value, selecting a second range of discrete values which is shifted in a desired direction relative to said first range, then said driver causes said printhead to apply ink to said print media in a second plurality of patterns corresponding to said second range of discrete values, and then a user visually inspects said second plurality of patterns and selects a desired discrete value from said second plurality of patterns by actuating said user input device.

The invention further provides a hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, said size being capable of having one of a plurality of discrete values within a range of values, wherein the device includes a driver for causing said printhead to apply ink to a print media in a plurality of patterns, each pattern corresponding to a respective one of said discrete values of said size, and the device further includes a user input device for selecting a desired discrete value as a result of visual inspection of said patterns.

The invention also provides a method of calibrating such a hardcopy device for a printing operation, wherein the driver causes the printhead to apply ink to said print media in said plurality of patterns, and a user selects a desired discrete value, as a result of visual inspection of said patterns, and enters a corresponding input in said user input device.

As used herein the term “hardcopy device” includes not only printers, but also graphics plotters, photocopiers, scanners and facsimile machines.

As used herein the term “ink” includes coloured inks and also other liquids, such as “fixer” which can be printed on print media. A fixer is a liquid applied to print media to fix another liquid on the media, i.e. to restrict the spreading of the other liquid through the print media from the location where the other liquid is originally applied.

As used herein the expression “unidirectional printing” means that one only prints in one direction (for example from right to left and not when the carriage is returning from left to right). “Bidirectional printing” means that one prints when the carriage is moving to both sides, from right to left and then from left to right.

### BRIEF DESCRIPTION OF THE DRAWINGS

Preferred embodiments of the present invention will now be described, by way of example only, with reference to the accompanying drawings, of which:

FIG. 1 is a schematic view of a printer of known type;

FIGS. 2a, 2b, 2c show printing with, respectively, a correct print media advance, an underadvance and an overadvance;

FIG. 3 is a graph showing a curve used in determining seven test print patterns in an embodiment of the present invention, the vertical axis representing the delta value (or difference) in microns in print media advance between different patterns in a set; and

FIG. 4 is an enlarged view of the front panel of a printer in accordance with an embodiment of the present invention.

### DESCRIPTION OF THE PREFERRED EMBODIMENTS

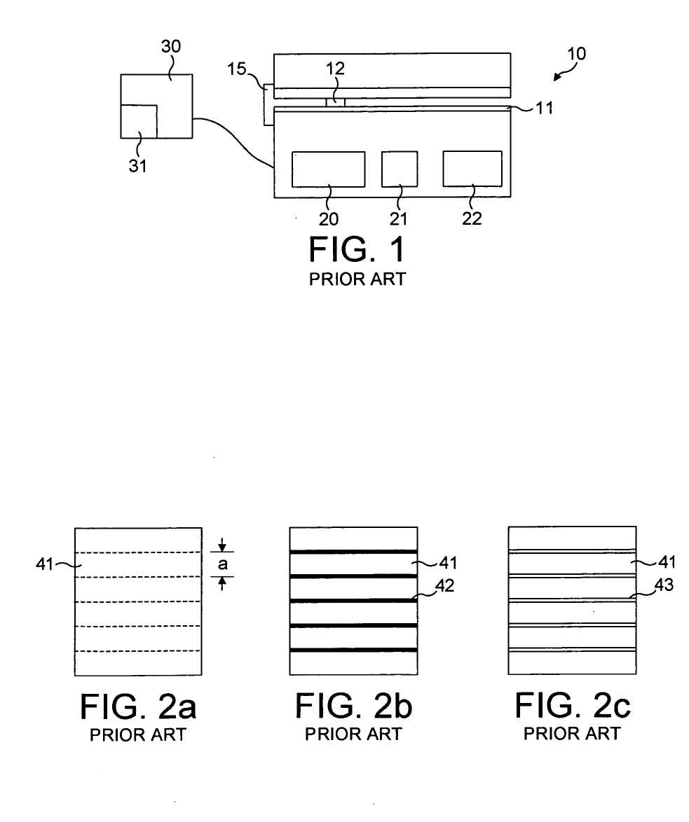

Referring to the drawings, FIG. 1 shows an ink-jet printer 10 of known type. The printer comprises a printhead 12 for applying ink to a print media 11. The printhead 12 can be a scanning-type printhead or a fixed printhead extending across the entire printer 10 in a page-wide array configuration. The printer comprises a print media advance mechanism 15 for moving the print media 11 past the printhead 12 by a succession of controlled advance movements. The size of the advance is controlled by a keyboard on a control panel 20 of the printer in co-operation with a printer computer 21. Alternatively, or in addition, the print media advance can be controlled remotely by a driver 30, incorporating a computer 31.

FIG. 2 indicates the bands or swaths 41 printed across a print media 11 in successive applications or ink by a printhead 12. If the print media advance “a” (sometimes known as “slope”) is precisely correct, then adjacent edges swaths 41 touch, but do not overlap, so that an uninterrupted uniform area of ink can be applied to the print media as shown in FIG. 2a. The dotted lines represent the boundaries between adjacent swaths and are not actually visible.

FIG. 2b shows the situation of the size of the print media advance is too small. Here, bands 42 are formed where the ink of adjacent edges of the swaths 41 overlaps or merges to form lines of increased ink density. This leads to a visible defect in images printed and a reduction in print quality.

FIG. 2c shows the situation of the size of the print media advance is too large. Here, gaps 43 appear where the ink of adjacent edges of swaths 41 do not meet to form lines of reduced or zero ink density. This also leads to a visible defect in images printed and a reduction in print quality.

A first embodiment of the present invention is based on the realisation that the size of the dot placement error depends not only on the type of print media being used and on external conditions but also on the print mode and on the ink density being used in the job to print.

Depending upon the print mode selected, a number of passes is undertaken so that, after completion of said passes, ink has been distributed substantially uniformly over the paper or other print media. This has a direct relation with the paper expansion. Although the quantity of ink laid on the paper is at the end the same, it is not equivalent in terms of expansion whether this ink has been fired in one single pass (fast print modes) or in two or more passes (normal or best print modes). The absorption of water by the cellulose fibers of paper is neither reversible nor a linear phenomenon, and also depends on time.

For instance, in a bond paper, applying the ink in one pass unidirectional print mode (unidirectional means more time between passes) generates 12 microns more expansion over a total length of 41 mm than the same print mode but with bidirectional printing (faster, so less time to expand). Furthermore, on the same media type, a print mode of two passes (slower, more time to expand), expands an extra 41 microns per 41 mm than the same print mode of the single pass. The distance 41 microns is the typical size of a full dot, an amount of error that needs to be compensated to obtain artefact-free images. Although a higher number of passes implies more time to expand, it also allows a major opportunity to hide the expansion with ink from the several passes and at the end it contributes to robustness of the image quality.

As a consequence, different media advance settings are employed for fast, normal and best print modes and for each type of paper, as each has a different expansion behaviour and media size.

The setting of the size of the media advance is also subjected to a correction in respect of the ink density of the job.

Depending on the type of plot (images, drawings or text) the ink density laid on the paper is very different. The present embodiment permits a correction in the advance setting taking into account this aspect and therefore optimizing the dot placement error in function of the ink density of the plot. As a consequence, different advance settings are employed for images and for drawings and/or text. A user of the printer 10 selects by means of a user input device in the form of a panel 20 or driver 30 the settings which best match the required type of plot.

For the calculation of the expected expansion, a typical value of 50% to 75% ink density is chosen for images, while the CAD lines or text, typical chosen ink densities are 5% to 25%. The correction depends on the media type and size, but it always advances more when the ink density is higher (to accommodate for the larger expansion of the media).

In practice, the following formula is used to calculate the size of each print media advance movement:

$$a ( ACT ) = \frac{a ( Nom )}{1 - c}$$

where a (Act) is the actual advance distance
a (Nom) is the nominal advance distance
   and c is a correction factor which is a function of media type, print mode, ink density and media width.

Thus a final calculation for the size of the print media advance setting can be a reference setting plus or minus a setting adjustment dependent on an entry by a user (e.g. whether image or lines) plus or minus a setting adjustment determined by the computer 21, 31 (e.g. based on media type, selected print mode etc).

An advantage of the above-described arrangement is that it increases image quality robustness to different ink densities and different print modes as well as to different types of paper. In addition it is relatively simple for a user to input the necessary information.

In a modification, only one of the various factors may be taken into account when selecting the amount of print media advance. Alternatively, only some but not all of the various factors may be taken into account.

Alternatively, or in addition, the media advance setting chosen may also depend on whether the print media 11 is in the form of a continuous roll or separate sheets.

All of the correction factors maybe calculated by the computer 21 or 31. Alternatively, they can be stored in one or more look-up-tables in a printer memory 22.

A second embodiment of the present invention is based on the realisation that, although print media advance settings can readily be determined for an extended list of proprietary papers (or other print media), there are other non-proprietary papers that are widely used in the market and need a tool to calibrate the paper advance. Furthermore, paper properties change with environmental conditions and there might be the necessity to re-calibrate the advance of a hardcopy device to obtain a good image quality in different places. This embodiment seeks to obtain a print media advance setting with improved accuracy and moreover taking into account some of the different external conditions that may affect the print quality, especially in a large format printer (such as external temperature or relative humidity).

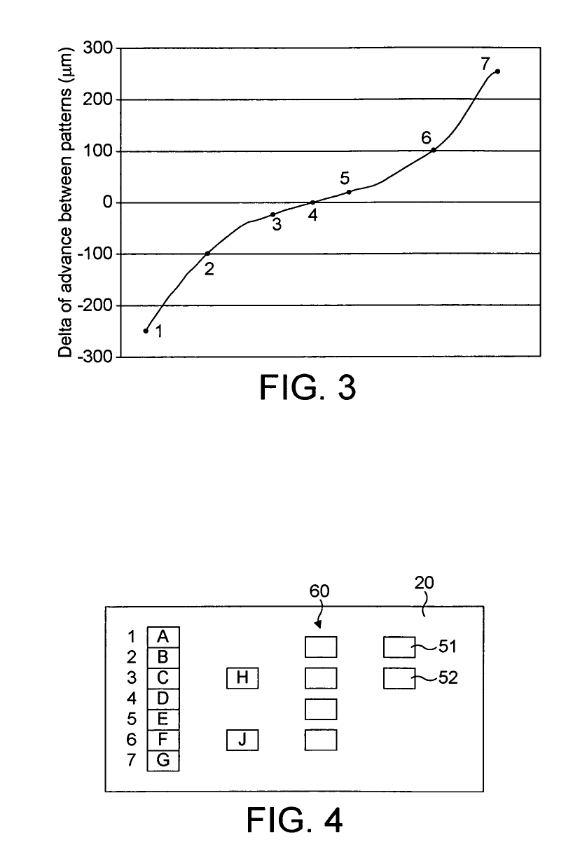

In this embodiment, seven calibration patterns are printed out by the printer 10 on the print media 11. The “delta values”, or differences between advances of adjacent sizes, are not equal but follow a non-linear curve as shown in FIG. 3. Here, the seven patterns 1 to 7 correspond to the options available for the print media advance size. Pattern 4 is the central pattern and is the default option originally set in the printer and defines the datum point zero for identifying the delta values of the other six settings 1-3 (which have a negative delta value, i.e. a smaller advance size) and 5-7 (which have a positive delta value, i.e. a smaller advance size).

The pattern 4 of the default option corresponds to HP Productivity Photo Gloss™ paper which is selected for its robustness and lack of expansion. HP Productivity Photo Gloss™ is a proprietary HP name for a glossy paper. All other proprietary papers are referenced relative to HP Productivity Photo Gloss™, so that by appropriate print media selection by a user via buttons 60 on the front panel 20, FIG. 4, the printer correspondingly sets pattern 4 as the correct value to advance that specific paper. Although only four buttons 60 are shown in FIG. 4, any number may be provided in accordance with the number of types of proprietary paper.

A different set of seven values is provided for each possible print mode. The applicable print mode may be selected by a user pressing one or more corresponding buttons 51, 52 on the front panel 20, FIG. 4. For a single pass print mode for drawings or text the curve shown in FIG. 3 may advantageously correspond to
y=3.3333x³−40x²+196.67x−360

For a single pass print mode for images, the curve may advantageously correspond to
y=8.0000x³−100x²+474.52x−831.43

In use, the printer 10 is set up for a particular printing operation and this determines the particular set of seven values selected. The seven patterns are then printed out on a test region of print media 11. After visual inspection of the seven patterns printed, the user then identifies the best one, i.e. the one that most clearly resembles the ideal pattern shown in FIG. 2a. The front panel 20 shown in FIG. 4 includes seven buttons A-G corresponding to patterns 1-7 and the user presses the appropriate one to ensure that the size “a” of the print media advance is optimally set for a subsequent printing operation.

The above-described arrangement has the advantage of high resolution and thus high accuracy in the region of the central patterns, which will correspond to the conditions applying to most printing operations. For non-proprietary types of paper (which will be discussed subsequently), and for temperatures and relative humidities significantly different from normal, the outer regions of the range are relatively-widely spaced so as still to be able to calibrate such printing operations. Thus calibration can still be achieved, even though accuracy may not be ideal.

Because the calibration is undertaken immediately before a printing operation, the same environmental conditions apply and all types of variation are corrected.

The calibration is preferably undertaken in single or “fast” print mode. Firstly, this enables calibration to be performed relatively quickly. Secondly, any media advance errors are more noticeable in “fast” print mode, due to the lower number of passes.

In a modification, the number of patterns in each set, or some of the sets, may be greater than seven, though this increases the time taken to undertake a calibration process. In another modification, the number of patterns in each set, or some of the sets, may be less than seven, though this decreases the accuracy and/or the range of the calibration.

A further modification of the second embodiment provides the possibility of an intermediate selection, i.e. selection of a delta value between those of 1 to 7 corresponding to buttons A to G. Thus, if it is apparent that the ideal setting lies between patterns 4 and 5, the front panel 20 offers the user the possibility of selecting a print media advance size which lies half way between the sizes corresponding to patterns 4 and 5 (i.e. buttons D and E).

To make this choice, a user presses both button D and a user input device in the form of a further button H, which adjusts the print media advance size by the additional amount (i.e. corresponding to a half-delta value).

This arrangement improves the accuracy of calibration without substantially increasing the calibration time or the number of patterns requiring study.

In a modification, button H can be replaced by six buttons, corresponding respectively to the half-way positions between respective pairs of adjacent buttons of the set A-G.

As stated above, HP Productivity Photo Gloss™ paper is used to set the basic printer media advance size “a”. If one is intending to print with a non-proprietary Heavy Weight Paper the exact media advance for that paper is not known and use of the setting for the corresponding proprietary paper may produce a poor print quality. Accordingly, a calibration operation should be undertaken. The nearest proprietary paper is Heavy Weight Paper which is a paper of 120 g and has an advance setting (delta value) of 100 μm with respect to HP Productivity Photo Gloss™ paper, because of its different qualities of thickness, composition, calliper etc. Actuation of the printer calibration mode will then cause patterns 1 to 7 to be printed out. Taking into account the just-described modification, this will produce the following options:

Pattern 1: +100-200=−100

Between 1 and 2: +100−150=−50

Pattern 2: +100−100=0

Between 2 and 3: +100−70=+30

Pattern 3: +100−40=+60

Between 3 and 4: +100−20=+80

Pattern 4: +100+0=+100

Between 4 and 5: +100+20=+120

Pattern 5: +100+40=+140

Between 5 and 6: +100+70=+170

Pattern 6: +100+100=+200

Between 6 and 7: +100+150=+250

Pattern 7: +100+200=+300

It will be seen that pattern 4 corresponding to a +100 μm would be best for the proprietary paper. Assuming that the delta value for the non-proprietary paper is +100 μm compared to the corresponding proprietary paper, then pattern 6 (i.e. +200 μm compared to HP Productivity Photo Gloss™ paper) should give the best print quality.

In a further modification, the use of such intermediate settings can be undertaken in conjunction with patterns 1-7 which correspond to print media advance sizes “a” which are equally-spaced (i.e. have equal delta values) rather than being arranged non-linearly as shown in FIG. 3.

Thus it will be seen that a calibration operation can be advantageously performed:
(i) when printing at extreme conditions of humidity or temperature causing print quality problems due to lack of media advance accuracy;
(ii) in any other situation where it is found empirically that print quality is being adversely affected by print media advance inaccuracies; and
(iii) when printing with some non-proprietary papers.

A third embodiment of the present invention enables a user to calibrate for printing operations, and in particular for print media, which would be otherwise off the scale. If a user wishes to use non-proprietary Heavy Weight Coated Paper, there will be no way to select this on the front panel 21. The best guess a user can make is to identify the closest proprietary paper, in this case the Heavy Weight Paper described in the example above. Let it be assumed that the non-proprietary paper requires an advance (delta value) of +500 μm relative to HP Productivity Photo Gloss™ (but of course the user will not know this).

Printing out the seven patterns corresponding to (proprietary) Heavy Weight Paper would produce Patterns 1 to 7 with dark bands of reducing thickness. However, if Pattern 7 were selected there would be overlapping bands of 200 μm which would still give unsatisfactory print quality.

Accordingly, in the third embodiment, a so-called recursive or repeat calibration is undertaken by undertaking a second calibration exercise with the delta value of the previous Pattern 7 corresponding to the new Pattern 4. Thus the user presses button G and a further, recursive calibration, button J.

The new patterns printed now correspond to the delta values shown below:

Pattern 1: +300−200=+100

Between 1 and 2: +300×150=+150

Pattern 2: +300×100=+200

Between 2 and 3: +300−70=+230

Pattern 3: +300−40=+260

Between 3 and 4: +300−20=+280

Pattern 4: +300+0=+300

Between 4 and 5: +300+20=+320

Pattern 5: +300+40=+340

Between 5 and 6: +300+70=+370

Pattern 6: +300+100=+400

Between 6 and 7: +300+150=+450

Pattern 7: +300+200=+500

Thus it will be seen that selection of new Pattern 7 for the non-proprietary paper will permit a subsequent printing operation of acceptable quality.

An advantage of the third embodiment is that, with an appropriate number of iterations, all kinds of print media an be calibrated in all environmental conditions to which the printer can be exposed.

In a modification, the second printing pattern can have new Pattern 1 (or Pattern 2 or Pattern 3) corresponding to old Pattern 7.

In another modification the third embodiment can also be applied to arrangements in which Patterns 1 to 7 correspond to print media advance sizes “a” which are equally-spaced (i.e. have equal delta values) rather than being arranged non-linearly as in the examples.

The features of each of the various embodiments and each of their modifications may be interchanged or combined as desired.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, wherein said adjusting device is capable of adjusting said size to have an increased resolution, at least in a part of said range.

2. A hardcopy device as claimed in claim 1, wherein said printing parameters are selected from a first group of parameters comprising print media being employed and environmental conditions, and wherein said adjusting device adjusts said size to have said increased resolution in dependence upon or more of a second group of parameters comprising print mode being employed, ink density, print media width and whether a sheet or roll media is being used.

3. A hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, wherein said printing parameters include at least one of print mode being employed and ink density.

4. A hardcopy device according to claim 3 comprising a detector for detecting at least one of said printing parameters, and a computer for determining said size in response to said detector.

5. A hardcopy device according to claim 3, comprising a user input device for inputting at least one of said printing parameters, and a computer for determining said size in response to said user input device.

6. A hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, said size being capable of having one of a plurality of discrete values within a range of values, wherein the said values are distributed within said range in non-linear manner.

7. A hardcopy device according to claim 6, wherein said values are closer together in the centre of said range than towards the ends of the range.

8. A hardcopy device according to claim 6, wherein the device includes a driver for causing said printhead to apply ink to a print media in a plurality of patterns, each pattern corresponding to a respective one of said discrete values of said size, and the device further includes a user input device for selecting a desired discrete value as a result of visual inspection of said patterns.

9. A hardcopy device according to claim 8, wherein said user input device is capable of selecting an intermediate value of said size, lying between said discrete values in said range.

10. A hardcopy device according to claim 8 including a user input device for setting a central value of said range of values.

11. A hardcopy device according to claim 6, wherein said printing parameters are selected from the group consisting of print mode being employed, ink density, print media width and whether a sheet or roll media is being used.

12. A method of calibrating a hardcopy device according to claim 8 for a printing operation, wherein in a first printing step, said driver causes said printhead to apply ink to said print media in a first plurality of patterns corresponding to a first range of discrete values, and, in the event that visual inspection reveals that none of said patterns in said first plurality corresponds to a desired discrete value, selecting a second range of discrete values which is shifted in a desired direction relative to said first range, then said driver causes said printhead to apply ink to said print media in a second plurality of patterns corresponding to said second range of discrete values, and then a user visually inspects said second plurality of patterns and selects a desired discrete value from said second plurality of patterns by actuating said user input device.

13. A method according to claim 12, wherein said second range is substantially centred on an end value of said first range.

14. A hardcopy device including a printhead for applying ink to a print media and a print media advance mechanism for advancing the print media in successive movements past the printhead between ink application operations, said print media advance mechanism including a device for adjusting the size of said successive movements in dependence on printing parameters, said size being capable of having one of a plurality of discrete values within a range of values, wherein the device includes a driver for causing said printhead to apply ink to a print media in a plurality of patterns, each pattern corresponding to a respective one of said discrete values of said size, and the device further includes a user input device for selecting a desired discrete value as a result of visual inspection of said patterns.

15. A hardcopy device according to claim 14 including a user input device for setting a central value of said range of values.

16. A hardcopy device according to claim 14 wherein said printing parameters are selected from the group consisting of print mode being employed, ink density, print media width and whether a sheet or roll media is being used.

17. A method of calibrating a hardcopy device according to claim 14 for a printing operation, wherein in a first printing step, said driver causes said printhead to apply ink to said print media in a first plurality of patterns corresponding to a first range of discrete values, and, in the event that visual inspection reveals that none of said patterns in said first plurality corresponds to a desired discrete value, selecting a second range of discrete values which is shifted in a desired direction relative to said first range, then said driver causes said printhead to apply ink to said print media in a second plurality of patterns corresponding to said second range of discrete values, and then a user visually inspects said second plurality of patterns and selects a desired discrete value from said second plurality of patterns by actuating said user input device.

18. A method according to claim 17, wherein said second range is substantially centred on an end value of said first range.
